(19) United States
(12) Patent Application Publication
(10) Pub. No.: US 2013/0153655 A1
(43) Pub. Date: Jun. 20, 2013

(54) SELF SERVICE RETAIL CHECK OUT USING SMART PHONE

(71) Applicant: Barbara W. Dawkins, Lawrenceville, GA (US)

(72) Inventor: Barbara W. Dawkins, Lawrenceville, GA (US)

(21) Appl. No.: 13/326,484

(22) Filed: Dec. 15, 2011

(51) Int. Cl. G06K 15/00

(52) U.S. Cl. 235/383

(57) ABSTRACT

A method of operating a retail check-out station. A customer selects items to be purchased, and scans bar codes attached to the items, using a cell phone camera. The bar codes identify the items. The cell phone extracts data from multiple bar codes and assembles the data into a different type of code, such as a 2-D bar code. The cell phone prints out the 2-D bar code, either on paper or on its display. The check-out station scans the 2-D bar code to obtain the identities of the items, and completes the transaction.

### BACKGROUND OF THE INVENTION

This Background will first describe a retail environment, a problem which arises, and then a solution.

### Retail Environment

FIG. 1 is a bird's eye view of a schematic of five check-out stations A through E in a retail store. Stations A through C are staffed by cashiers, as indicated. Stations D and E are self-service check-out stations, which are not staffed by cashiers.

Each station A-E examines a respective group of purchased items PI, and identifies each item within each group, as by scanning bar codes on the items, so that the price of each item can be tallied.

Each station A-E generally prints a paper receipt PR for the customer. In addition, each station A-E stores some, or all, of the data contained in the receipts PR within a central computer C. The stored data are represented by files F.

FIG. 2, left side, is a representation of a hypothetical paper receipt PR. It indicates that station A in FIG. 1 produced the paper receipt PR, and states the date and time of the sale. It also indicates the identities of the purchased items PI in FIG. 1, together with their prices. This data can collectively be termed scanned data, and is indicated by the dashed box SD in FIG. 2. The data is termed scanned because it is commonly obtained by scanning barcodes contained on the items purchased.

The paper receipt PR in FIG. 2 also contains a total cost for the sale, and other data, such as (1) the name of the customer, or patron, and (2) how the bill was paid, as by cash payment, credit card payment, or another type of payment, and so on.

Some, or all, of the data indicated on the paper receipt PR is stored in the computer file F, also indicated in FIG. 1, within the computer C of FIG. 1. In addition, other data, relevant to the accounting system of the retail store, can be stored within the file F, as indicated by the other data OD.

Therefore, as so far described, a computer record, indicated by the files F in FIG. 1, is generated for each transaction undertaken by a patron of the retail store. The check-out stations A-E generate data for each file F.

### PROBLEM AND SOLUTION

It sometimes happens that the retail store becomes crowded with patrons P in FIG. 3, who must line up in queues Q, and wait for available check-out stations. The retail store can respond to this situation by equipping an employee E in FIG. 4 with a portable scanner S1. The employee E pre-scans the bar codes (not shown) of the items 25 of a patron P1 waiting in a queue. The scanned bar codes are stored in the computer C as a file F1. Patron P1 is given a ticket, token, or other indicator, which identifies the file F1.

When patron P1 reaches the check-out station C, he tenders the ticket/token, which allows the file F1 to be retrieved. Then the transaction completes. If the station is staffed by a person, the person reads the ticket/token in an appropriate manner. If the station is a self-service station, then person P1 presents the ticket/token to a scanner for reading.

The portable scanner S1 can be viewed as a check-out station resembling station D, but with reduced capabilities. For example, scanner S1 would lack a weighing scale, and the ability to accept cash.

Consequently, when scanner S1 scans the items of patron P1, the overall system sees the initiation of an ordinary check-out transaction. However, when the scanning of the items of patron P1 is completed, that ordinary transaction is not completed, but is suspended instead. Then, when patron P1 reaches station C, the ticket/token is used to retrieve file F1, and the transaction is resumed, and it completes.

During the time delay, between (1) the start of scanning of the items of P1 by scanner S1 and (2) the tendering of the ticket/token by P1 to a station, that station was processing the purchases of other customers.

It is pointed out that the transaction for P1 is broken into two sub-transactions. One is the scanning (sometimes called pre-scanning) of the items of patron P1, which identifies the items which P1 wishes to purchase. The second is the tallying of the bill for P1 and acceptance of payment, together with any other overhead steps required. The second step occurs at station C in FIG. 4, since the first step has already occurred before patron P1 arrived at station C.

Thus, patron P1 experiences a benefit. The time spent by patron P1 at the station C, after waiting in the queue, is reduced. Further, in many cases, the total time spent by P1, including time in the queue, has been reduced.

However, while patron P1 is benefited, this process may have a disadvantage to the retail store itself. That disadvantage can lie in the fact that portable scanner S1 is, in essence, a miniature version of an ordinary self-service check-out station D. As such, it is not a generic item which is available for purchase by the retail store. It probably must be purchased from the manufacturer of the overall system of check-out stations A-E.

By analogy, in the automotive world, power steering pumps are not interchangeable. A power steering pump for a vehicle A will probably not fit a vehicle B, because the two vehicles are made by different manufacturers. Similarly, a portable scanner S1 in FIG. 4 manufactured by Company A probably cannot be used with a checkout system manufactured by Company B.

### OBJECTS OF THE INVENTION

An object of the invention is to provide an improved check-out system for retail stores.

A further object of the invention is to provide an improved system for reducing queues which form at check-out stations in retail stores.

### SUMMARY OF THE INVENTION

In one form of the invention, a patron scans bar codes on items to be purchased, using a cell phone, smart phone, or other portable device. The bar code data is then conveyed to a check-out station directly by the patron. The check-out station then completes the transaction, using the patron's bar code data.

### BRIEF DESCRIPTION OF THE DRAWINGS

FIG. 1 is a bird's eye view of check-out stations A-E in a retail store.

FIG. 2 illustrates contents of a paper receipt PR in FIG. 1, together with a computer file F which stores some, or all, of the data of the paper receipt PR.

FIG. 3 shows stations A-E of FIG. 1, with patrons P lined up in queues Q, awaiting available check-out stations.

FIG. 4 is a rendition of FIG. 3, with an added scanner S1, which is operated by an employee E.

FIG. 5 illustrates one form of the invention.

FIG. 6 illustrates a cell phone CP displaying a 2-D bar code 30.

FIG. 7 illustrates a cell phone CP displaying four different linear bar codes, in sequence.

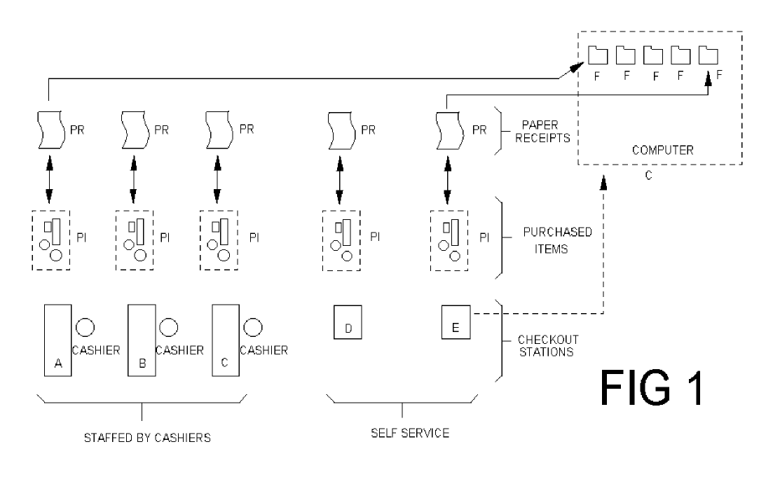

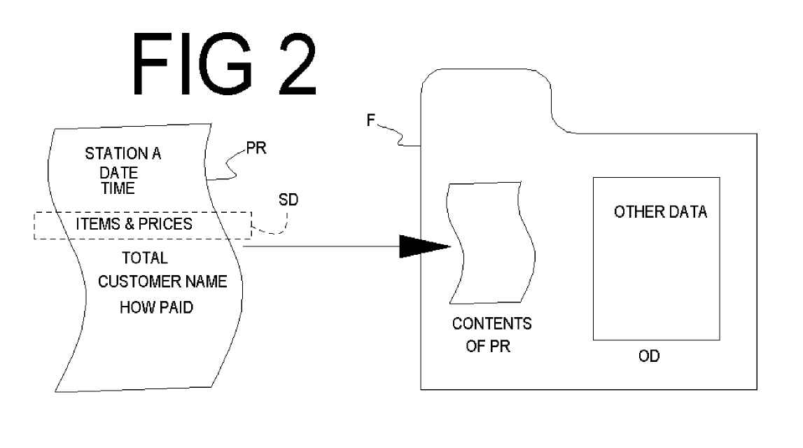

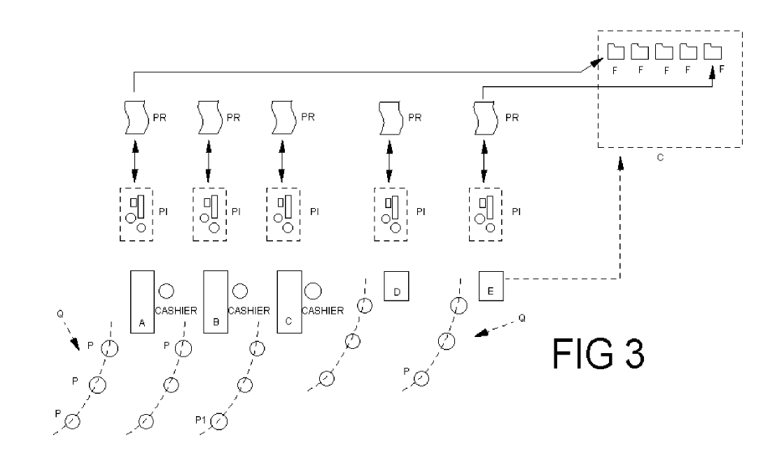

### DETAILED DESCRIPTION OF THE INVENTION

This discussion will first (1) explain an improvement over the approach described in the Background of the Invention, and then (2) illustrate an alternate approach.

The approach described in the Background of the Invention accomplishes three tasks. One task is scanning the items of patron P1, while P1 stands in a queue Q. Scanning the items of P1 identifies the items and places the identifying data into a format usable by computer programs.

A second task is storing that identifying data in a location which is available to a check-out station, namely, in computer C. A third task is enabling a check-out station to select, from computer C, the identifying data corresponding to patron P1. That is, computer C stores identifying data for numerous patrons. The data for patron P1 must be selected from that collection of identifying data. The ticket/token described above facilitates this third task.

### Preliminary Matters

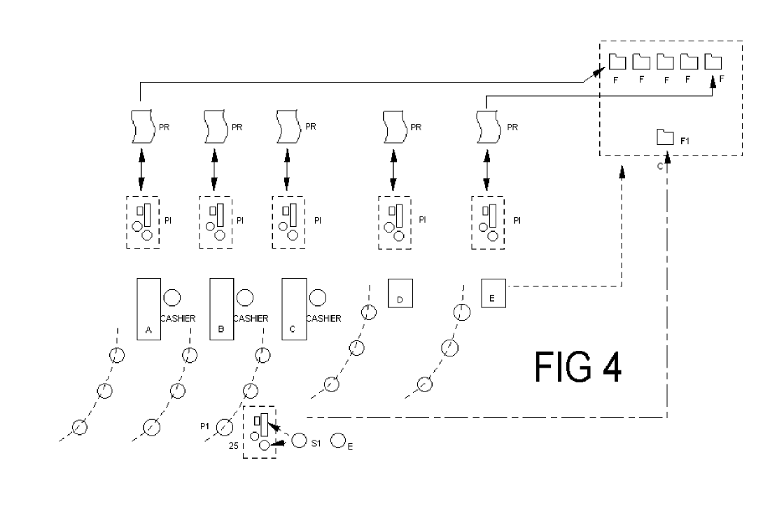

In the approach of the Background of the Invention, scanner S1 in FIG. 4 was used by an employee. In an alternate approach, the retail store provides a collection of scanners S1 of FIG. 4, and makes them available to customers. This approach has the advantage that an employee E is not required to perform the scanning of the patrons' items.

Under the alternate approach, the identifying data of a patron's items is stored in the central computer C, as described above. However, the scanners S1 do not print out a ticket, or provide a token, as described above. Instead, the function of the ticket/token is provided by the customer.

For example, the scanner S1 may ask the patron to punch in an identifying number, such as the patron's telephone number, or a random number which the person fabricates on the spot. The data for the patron is then stored by using that number as an identifying number in a file name.

Alternately, the scanner can scan the patron's loyalty card, credit card, driver's license, or other ID card, and thereby secure a unique code for the patron's identifying data, and store the identifying data under that number.

However, this alternate approach shares a characteristic with the approach of the Background of the Invention, namely, that the identities of the items of a patron are still stored within computer C in FIG. 4. As a practical matter, that almost necessarily requires that (1) scanners S1 in FIG. 4 be owned by the retail store, and (2) the store's computer network be involved in accepting the scanned data and storing it until check-out occurs by the patron. This adds expense, in the form of capital cost and maintenance.

### SEVERAL FORMS OF THE INVENTION

Against the preceding background, Applicant presents another form of the invention. In brief, the patron starts a transaction-handling application on their own smartphone or other computing device. The smartphone application records each barcode scanned until the patron indicates the scanning is complete, which causes the application to generate a 2d barcode containing the product codes and other relevant transaction data in one barcode image. Then the patron delivers the scanned data directly to the check-out station via its optical barcode scanner. The checkout station processes the barcode data and sells each item code in the data, and applies loyalty information and coupon information if available. After the processing is complete the check-out station accepts tender from the patron and finalizes the transaction.

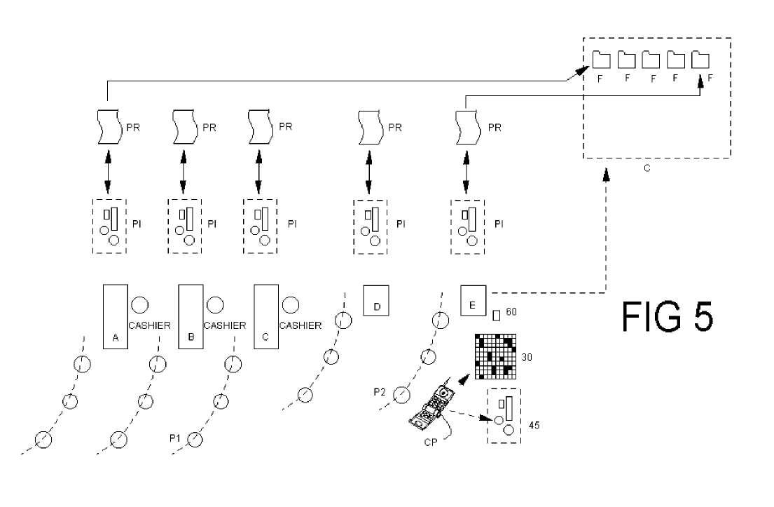

FIG. 5 illustrates patron P2, and a cell phone CP owned by that patron. The patron P2 scans each item within collection 45, using the cell phone CP. No employee of the retail store is involved in the scanning, nor is any equipment of the retail store involved. Specifically, no computer of the retail store acts as a storage location of the scanned data at this time, although after the sale a computer of the retail store will probably store some, or all, of the scanned data.

After all items in group 45 have been scanned, the cell phone CP then prepares a message containing the scanned data. That message can take the form of a 2-D, that is, two-dimensional, bar code, 30 which contains data identifying all the items.

2-D bar codes are well known and available in various formats, including QR (Quick Response) codes. In one form, they resemble miniature checkerboards, approximately the size of postage stamps. In the case of black-and-white 2-D bar code, each square in the checkerboard represents one bit of data. If colors are used, each square can represent more than one bit. For example, if eight colors are used, each square can represent a decimal number from one to eight, or, equivalently, three bits. The storage capacity of 2-D bar codes varies, but a good round estimate is one kilobyte of storage capacity.

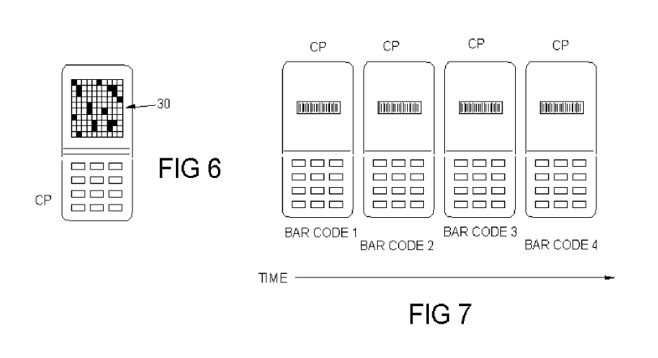

Block 30 in FIG. 5 represents the 2-D bar code. The cell phone CP can display the 2-D bar code 30 on its video display in FIG. 6, thereby creating a visual image of the code 30. The check-out station will then optically scan the video display to obtain the code 30, and its data contents. The check-out station optically reads the bar code 30 to obtain the scanned data, and then completes the sales transaction in the usual manner.

The cell phone CP can print the code 30 onto a sheet, and present the sheet to the check-out station.

In one form of the invention, the retail store is equipped with scanners at its check-out stations, which scan bar codes in the usual manner. However, the scanners possess the additional capacity of being able to read 2-D bar codes. Block 60 in FIG. 5 represents such a scanner, or a combination of (1) a prior art bar code scanner and (2) a 2-D bar code scanner. The latter scanner can be used for scanning purposes other than scanning 2-D bar codes which the cell phone CP generates.

With this arrangement, no additional equipment is required by the retail store, to allow patrons to scan their own items. Additionally, no loyalty program token or additional identifier is required other than the barcode or message produced by the phone. A patron scans the items, generates the 2-D bar code 30, presents the code 30 to a check-out station, which is either staffed or self-service, and the station reads the code 30 using a scanner which it uses for other purposes.

A significant feature of the invention is that the 2-D bar code is a visual image which contains data which with one scan can identify a list of items which the patron is purchasing. Although the 2D barcodes do have data size limits, they can be expected to contain up to 50 items, which is more than enough for most retail transactions. The barcode data can optionally include loyalty identifiers and coupon data. For exceptionally large transactions, multiple 2-D barcodes can be produced that are sequentially displayed. That data does not directly convey information describing the items in an ordinary human language, such as English or Spanish. Instead, each data item within the 2-D bar code is a number, or symbol string, which must be decoded in order to ascertain its meaning.

Of course, a skilled technician may be able to directly read the meaning of such codes. Nevertheless, such codes still do not convey the descriptive information in a human language. In this example, information is conveyed because the technician performs the decoding process mentally.

FIG. 7 illustrates another form of the invention. The data scanned from the items (such as scanned bar codes) is not assembled into a single 2-D bar code. Instead, linear bar codes representing single items, or 2D barcodes representing multiple items (in cases of transactions containing too many items for one 2D barcode) are displayed, in sequence, on the display of the cell phone CP of the patron. A scanner at the check-out station E reads the sequence of bar codes.

This is a type of serial data transfer, in which each unit in the transfer is an individual bar code, and the bar codes are displayed serially. This is distinct from the presentation of a 2-D bar code, for at least two reasons. One is that the 2-D bar code contains identifying data for multiple items. A second reason is that the 2-D bar code is a single graphical image, presented at one time (unless error correction requires a repeated presentation).

### ADDITIONAL CONSIDERATIONS

1. The items are labeled with one type of code, such as linear bar codes. That is, each item purchased by the patron may contain a unique linear bar code which identifies the item. However, the cell phone CP in FIG. 5 generates another type of code, such as a 2-D bar code, or another type of graphical image. The latter type of code generated by the cell phone CP (e.g., a 2-D bar code) is qualitatively different from the codes read from the items (e.g., bar codes). The two types of codes are decoded differently by scanners. Different algorithms are required to extract information from the two types of code.

2. In one form of the invention, the check-out stations A-E in FIG. 5, in general, do not scan bar codes of items a second time. That is, the 2-D bar code presented by the customer is used to identify the items which the customer purchases. The items listed in that 2-D bar code are not re-scanned by the check-out station. Exceptions may occur, as when mistakes arise. But one goal is to eliminate double scanning.

Numerous substitutions and modifications can be undertaken without departing from the true spirit and scope of the invention. What is desired to be secured by Letters Patent is the invention as defined in the following claims.

1. A method of performing a sales transaction with a customer at a check-out station in a retail store, comprising:
receiving, prior to check-out, an indication of one or more items the customer plans to purchase, wherein the indication comprises a customer identifier;
receiving, from the customer at the check-out station, a graphical image comprising an indication of the customer identifier;
optically scanning said graphical image to thereby deduce the customer identifier;
retrieving item information related to the one or more items using the customer identifier; and
using the item information to formulate a bill and complete the sales transaction for the items.

2. Method according to claim 1, in which the graphical image was generated by a portable telephone in possession of the customer, which
i) scanned linear bar codes on said items, and
ii) derived information from the linear bar codes, and
iii) transmitted the information from the linear bar codes.

3. Method according to claim 1, in which the check-out station does not scan items which are identified in the item information.

4. Method according to claim 2, in which the check-out station does not scan items which are identified in the item information.

5. Method according to claim 1, in which the graphical image comprises a 2-D bar code.

6. A method of performing a sales transaction with a customer at a check-out station in a retail store, comprising:
receiving, prior to check-out, an indication of one or more items the customer plans to purchase, wherein the indication comprises a customer identifier;
receiving, at the check-out station, a 2-D bar code which
comprises an indication of the customer identifier;
was generated by a cell phone of the customer which
scanned linear bar codes on said items, and
transmitted item information from the linear bar codes;
optically scanning the 2-D bar code to identify the customer identifier; and
retrieving item information related to the one or more items using the customer identifier to formulate a bill for the items, without scanning bar codes on the items.

7. Method according to claim 6, in which the check-out station does not scan items which are identified in the item information.

8. Method according to claim 6, in which the 2-D bar code is displayed by the cell phone, and the check-out station scans the displayed bar code.

9. Method according to claim 6, in which the check-out station receives the 2-D bar code by optically scanning the 2-D bar code.

10. A method of performing a sales transaction with a customer at a check-out station in a retail store, comprising:
receiving, prior to check-out, an indication of one or more items the customer plans to purchase, wherein the indication comprises a customer identifier
receiving the customer at a check-out station;
optically scanning, at the check-out station, a 2-D bar code which
is presented by a portable device in possession of the customer,
comprises an indication of the customer identifier;
was generated by the portable device which previously
scanned linear bar codes on said items, and
transmitted item information from the linear bar codes; and
retrieving item information related to the one or more items using the customer identifier to formulate a bill for the items, without scanning bar codes on the items.

11. The method of claim 1, wherein the customer identifier comprises an identifier selected from the group consisting of a loyalty card number, a phone number, a credit card number, and a driver's license number.

12. The method of claim 6, wherein the customer identifier comprises an identifier selected from the group consisting of a loyalty card number, a phone number, a credit card number, and a driver's license number.

13. The method of claim 10, wherein the customer identifier comprises an identifier selected from the group consisting of a loyalty card number, a phone number, a credit card number, and a driver's license number.
